(19) United States
(12) Patent Application Publication
(10) Pub. No.: US 2017/0361640 A1
(43) Pub. Date: Dec. 21, 2017

(54) ELECTRIC PENCIL SHARPENER

(71) Applicant: Jong Kwan Kim, Seoul (KR)

(72) Inventors: Jong Kwan Kim, Seoul (KR); Sung-Ho Cho, Gyeonggi-do (KR)

(21) Appl. No.: 15/335,641

(22) Filed: Oct. 27, 2016

(30) Foreign Application Priority Data
Jun. 17, 2016 (KR) 10-2016-0075968

(51) Int. Cl. B43L 23/02

(52) U.S. Cl. CPC B43L 23/02

(57) ABSTRACT

An electric pencil sharpener includes a motor configured to drive a cutter assembly for shaving a pencil, a cutter platform including a bracket configured to removably attach to the cutter assembly in a first direction, and a body cover shaped to cover the cutter platform, wherein the body cover includes an opening that opens toward the first direction and a pencil guide hole that opens toward a second direction. The opening is in communication with a receiving space of the bracket in which the cutter assembly is received, and wherein the cutter assembly is attachable to the bracket through the opening by a user, when the body cover covers the cutter platform.

### PRIORITY STATEMENT

This application claims priority under 35 U.S.C. §119 to Korean Patent Application No. 10-2016-0075968, filed on Jun. 17, 2016 in the Korean Intellectual Property Office (KIPO), the contents of which are herein incorporated by reference in their entirety.

### BACKGROUND

### 1. Field

Example embodiments relate to an electric pencil sharpener. More particularly, example embodiments relate to an electric sharpener including a cutter shaving a pencil using an electric motor.

### 2. Description of the Related Art

Electric pencil sharpeners, which are widely used in both home and office, are becoming increasingly in greater demand than a conventional manual pencil sharpener. However, in electric pencil sharpeners, when a pencil lead is broken and stuck in a cutter during shaving, the removal of the broken lead is even more troublesome and causes much inconvenience. Further, because many young students use electric pencil sharpeners, a foreign object other than wood of pencil casing gets stuck in the cutter, thereby causing a failure in the electric pencil sharpener.

Occasionally, in order to remove the broken lead or foreign object, a user may pick up or turn over the electric pencil sharpener thereby adversely affecting the sharpener itself and it may be inconvenient by reason of disassembling and reassembling the sharpener. Additionally, when a lead removing device is additionally provided, the cost of the sharpener may be increased and also an overall size may be increased. Further, in case that the lead is removed by counter-rotations of a motor, a removal effect of the lead is usually poor.

On the other hand, in case that a cutter is worn down by long-term use, because general customers cannot replace only the worn-down cutter, they should receive after-sale service of maker/technical personnel or should purchase a new sharpener.

### SUMMARY

Example embodiments provide an electric pencil sharpener capable of easily removing a broken lead during shaving or a foreign object and simply replacing a worn-out cutter with a new cutter without disassembling and assembling the sharpener.

According to example embodiments, an electric pencil sharpener includes a motor configured to drive a cutter assembly for shaving a pencil, a cutter platform including a bracket configured to removably attach to the cutter assembly in a first direction, and a body cover shaped to cover the cutter platform, wherein the body cover includes an opening that opens toward the first direction and a pencil guide hole that opens toward a second direction. The opening is in communication with a receiving space of the bracket in which the cutter assembly is received, and the cutter assembly is attachable to in the bracket through the opening by a user, when the body covers the cutter platform.

In example embodiments, the bracket may have at least one seating groove configured to support the cutter assembly.

In example embodiments, at least a portion of the seating groove may extend in the first direction to guide attachment and detachment of the cutter assembly from the bracket.

In example embodiments, the second direction may be substantially perpendicular to the first direction.

In example embodiments, the opening may be larger than the cutter assembly to pass through the opening.

In example embodiments, the electric pencil sharpener may further include an opening/closing door configured to open and close the opening.

In example embodiments, the opening may be provided in an upper side of the body cover.

In example embodiments, the cutter assembly may include a cutter holder having a pencil insertion aperture, a cutter supported by the cutter holder and rotatable about a cutter shaft, and an assembly housing configured to rotatate the cutter holder and having a ring gear in an inner circumferential surface, wherein the inner circumferential surface is shaped to engage with a planetary gear in an end portion of the cutter.

In example embodiments, the cutter assembly may further include a cutter gear fixedly connected to an end portion of the cutter holder and rotatable with the cutter holder.

In example embodiments, a central axis of the pencil guide hole may be aligned with a rotational axis of the cutter holder.

According to example embodiments, an electric pencil sharpener includes a body cover including a pencil guide hole in a first side and an opening in a second side, wherein the pencil guide hole extends in a first direction and the opening opens in a second direction, a cutter for shaving a pencil inserted through the pencil guide hole, a motor configured to drive the cutter, and a bracket within the body cover wherein the bracket is positioned to expose through the opening when the cutter is attached to the bracket, and wherein the cutter is configured to attach to and detach from the bracket through the opening by a user.

In example embodiments, the electric pencil sharpener may further include an opening/closing door configured to open and close the opening.

In example embodiments, the second direction may intersect with the first direction.

In example embodiments, the bracket may have a hollow socket shape with two open ends.

In example embodiments, the bracket may include a first seating groove to support a first end of the cutter and a second seating groove to support a second end of the cutter.

In example embodiments, the bracket may have a hollow receiving space in communication with the opening and shaped to receive the cutter unit.

In example embodiments, the electric pencil sharpener may further include a cutter holder having a pencil insertion aperture, wherein the cutter holder is configured to support the cutter and rotate the cutter about a cutter shaft, and an assembly housing configured to rotatably support the cutter holder and having a ring gear in an inner circumferential surface, wherein the cutter includes a planetary gear in an end of the cutter configured to engage with the ring gear.

In example embodiments, the pencil insertion aperture of the cutter holder may be seated in a first seating groove of the bracket and wherein the assembly housing may be seated in a second seating groove of the bracket.

In example embodiments, the cutter holder may include a cutter gear fixedly connected to an end portion of the cutter holder and rotatable with the cutter holder.

In example embodiments, a central axis of the pencil guide hole may be aligned with a rotational axis of the cutter holder.

According to example embodiments, an electric pencil sharpener may include an open bracket configured to receive a cutter assembly in a manner that the cutter assembly is removably attachable in a body cover through an opening of the body cover. The opening is in communication with a receiving space of the open bracket in which the cutter assembly is received.

Accordingly, a user may demount or mount the cutter assembly through the opening of the body cover as necessary. A user may simply open an opening/closing door and take out the cutter assembly through the opening without disassembling the body cover. Further, a user may mount the cutter assembly within the body cover through the opening of the body cover.

However, effects of the present inventive concept may not be limited to the above-mentioned effects, and may be extended without materially departing from the novel teachings and advantages of the present invention.

### BRIEF DESCRIPTION OF THE DRAWINGS

Example embodiments will be more clearly understood from the following detailed description taken in conjunction with the accompanying drawings. FIGS. 1 to 10 represent non-limiting, example embodiments as described herein.

FIG. 1 is a perspective view illustrating an electric pencil sharpener in accordance with example embodiments.

FIG. 2 is a plan view illustrating the electric pencil sharpener in FIG. 1.

FIG. 3 is an exploded perspective view illustrating the electric pencil sharpener in FIG. 1.

FIG. 4 is a plan view illustrating a cutter unit platform of the electric pencil sharpener in FIG. 1.

FIG. 5 is a perspective view illustrating a cutter unit of the electric pencil sharpener in FIG. 1.

FIG. 6 is a plan view illustrating the cutter unit platform having the cutter unit of FIG. 5 installed therein.

FIG. 7 is a perspective view illustrating the electric pencil sharpener in FIG. 1, with an opening/closing door removed therefrom.

FIG. 8 is a cross-sectional view taken along the line A-A′ in FIG. 7.

FIG. 9 is a perspective view illustrating the electric pencil sharpener in FIG. 7, with the cutter unit removed therefrom.

FIG. 10 is a perspective view illustrating an electric pencil sharpener in accordance with example embodiments.

### DETAILED DESCRIPTION OF EXAMPLE EMBODIMENTS

Various example embodiments will be described more fully hereinafter with reference to the accompanying drawings, in which example embodiments are shown. Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art. In the drawings, the sizes and relative sizes of components or elements may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element or layer is referred to as being “directly on,” “directly connected to” or “directly coupled to” another element or layer, there are no intervening elements or layers present. Like numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

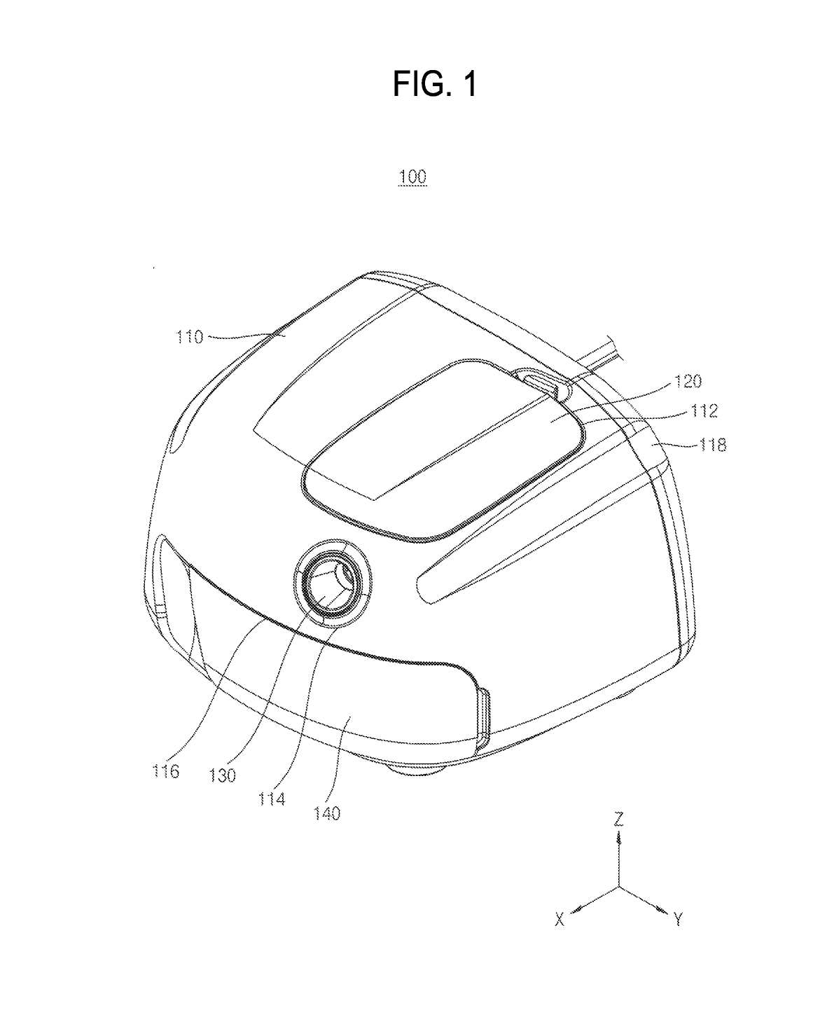

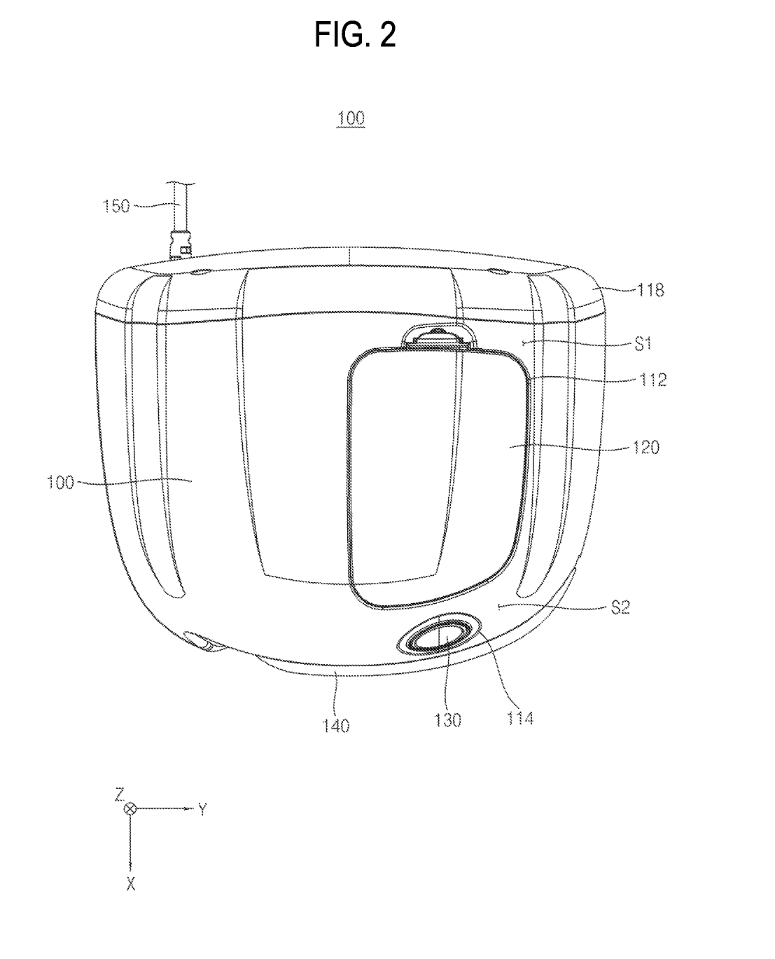

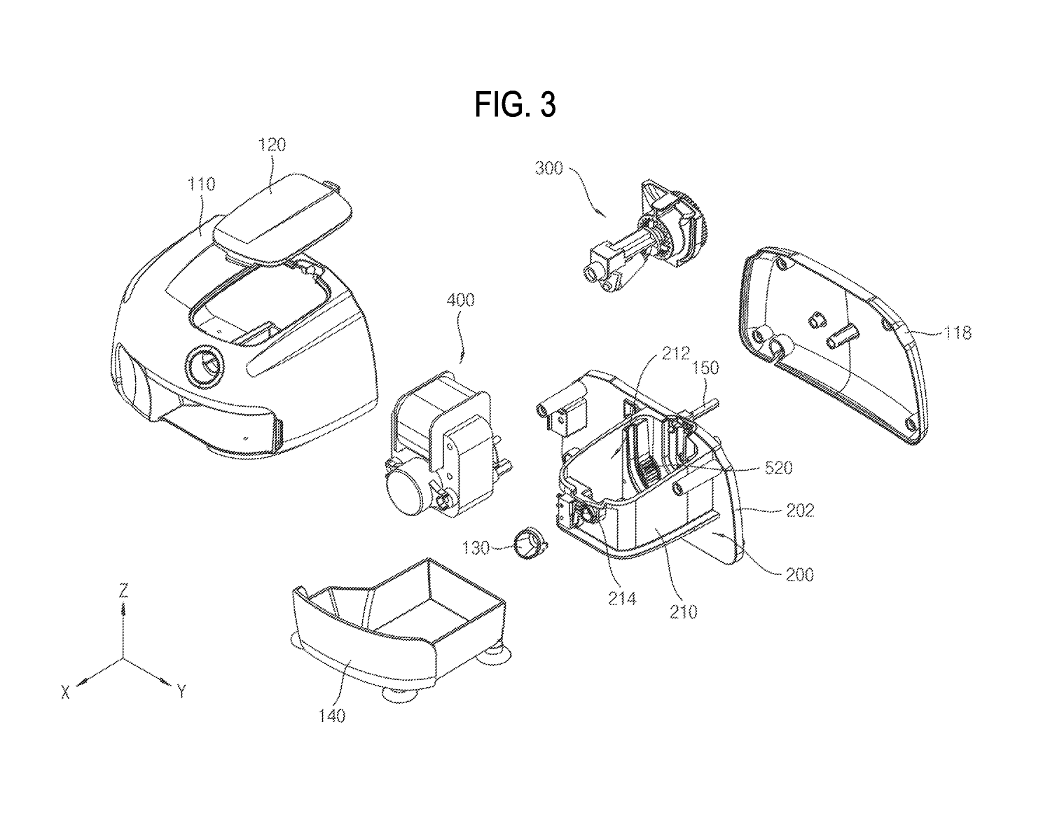

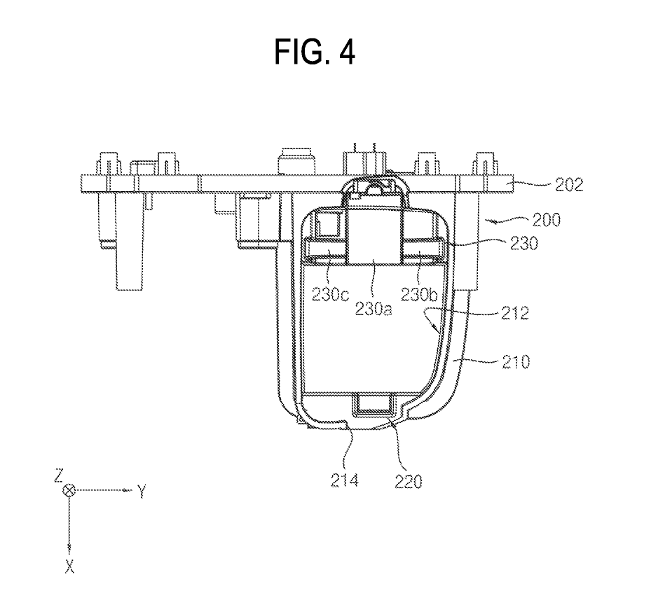

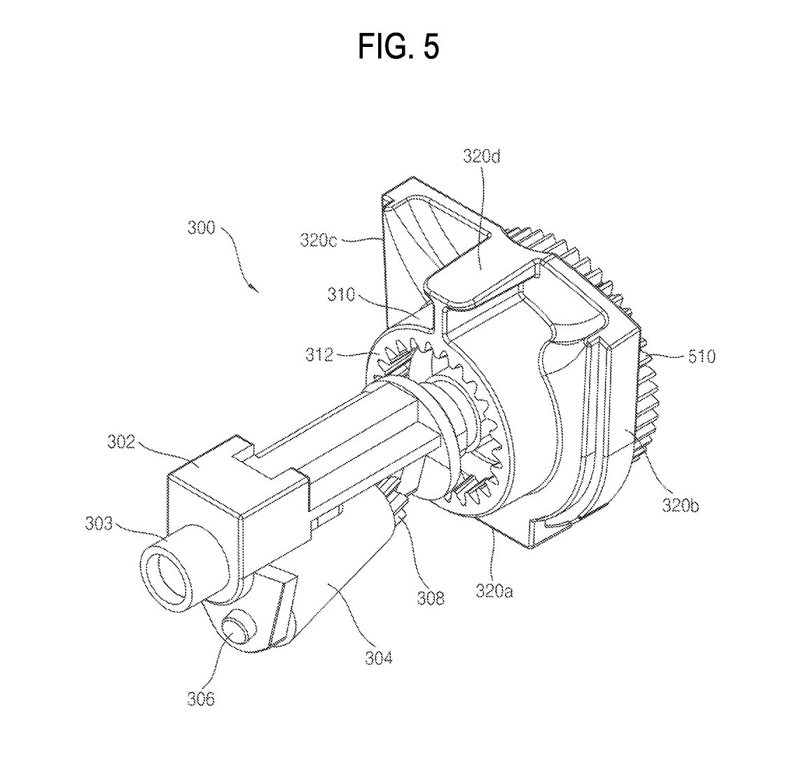

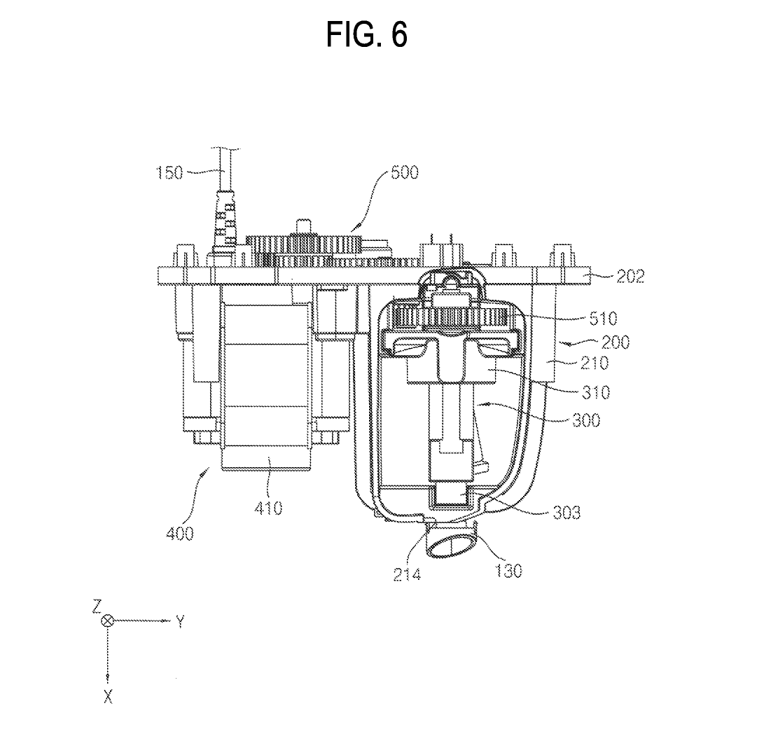

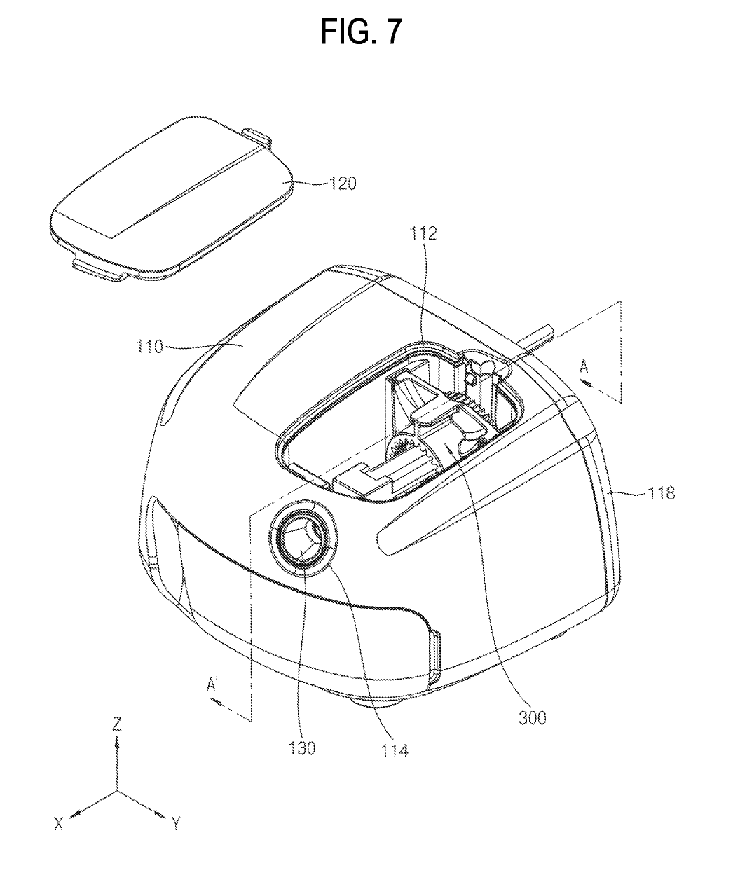

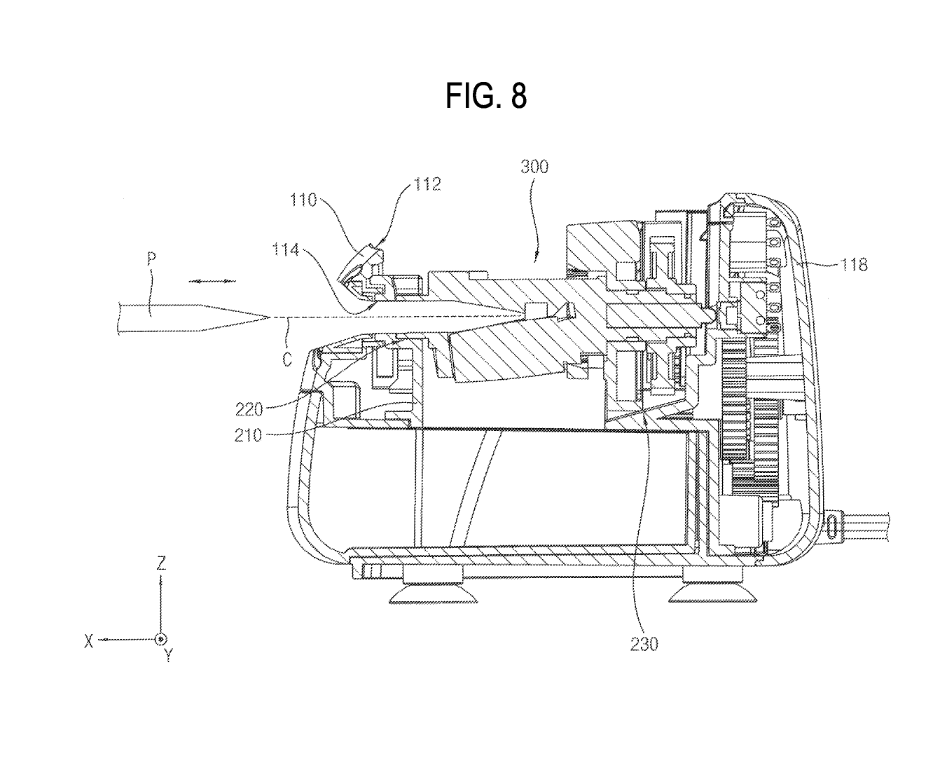

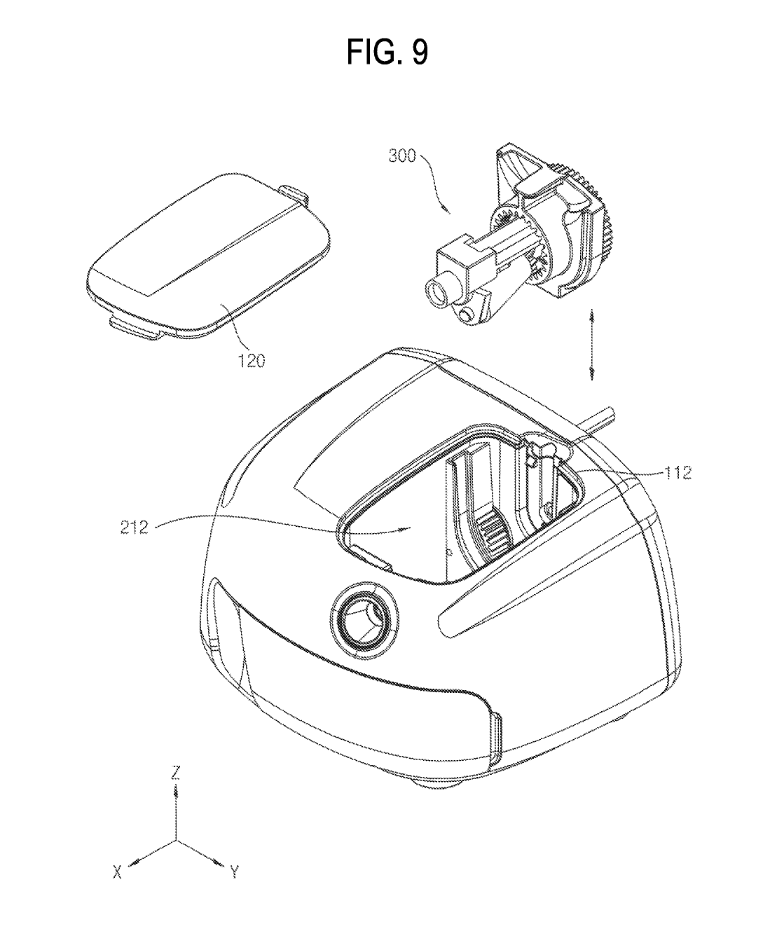

FIG. 1 is a perspective view illustrating an electric pencil sharpener in accordance with example embodiments. FIG. 2 is a plan view illustrating the electric pencil sharpener in FIG. 1. FIG. 3 is an exploded perspective view illustrating the electric pencil sharpener in FIG. 1. FIG. 4 is a plan view illustrating a cutter platform of the electric pencil sharpener in FIG. 1. FIG. 5 is a perspective view illustrating a cutter unit of the electric pencil sharpener in FIG. 1. FIG. 6 is a plan view illustrating the cutter platform having the cutter unit of FIG. 5 installed therein. FIG. 7 is a perspective view illustrating the electric pencil sharpener in FIG. 1, with an opening/closing door removed therefrom. FIG. 8 is a cross-sectional view taken along the line A-A′ in FIG. 7. FIG. 9 is a perspective view illustrating the electric pencil sharpener in FIG. 7, with the cutter unit removed therefrom. In all figures in this specification, a direction indicated by an arrow and a reverse direction thereof are considered as the same direction.

Referring to FIGS. 1 to 9, an electric pencil sharpener 100 may include a body cover 110, a cutter platform 200, a cutter unit 300, a motor unit 400, and a gear mechanism 500.

In example embodiments, the electric pencil sharpener 100 may be a pencil sharpener that sharpens a pencil using an electric motor. Accordingly, a motor 410 of the motor unit 400 may be operatively connected to a power supply such as direct current (DC) power source or alternating current (AC) power source. For example, the motor 410 of the motor unit 400 may be connected to the AC power source through a power cable 150. However, it may not be limited thereto, and the motor may be electrically connected to the DC power source such as a battery, which is received within the body cover 110.

As illustrated in FIGS. 1 and 2, the body cover 110 may be a box body having an overall rectangular parallelepiped shape. The body cover 110 may have an opening 112 in a first side S1, i.e., upper side, and a pencil guide hole 114 to which the pencil is inserted, in a second side S2, i.e., front side.

The body cover 110 may have a length in a first direction (X direction) in which the pencil is inserted through the pencil guide hole 114, and a width in a second direction (Y direction) substantially perpendicular to the first direction on a plane on which the body cover 110 is installed. Additionally, the body cover 110 may have a height in a third direction (Z direction) substantially perpendicular to the first and second directions. For example, the electric pencil sharpener 100 may have a transverse type of the body cover 110 having width greater than length.

The opening 112 may be opened toward the third direction, and the pencil guide hole 114 may be opened toward the first direction. The opening 112 may extend in the third direction, and the pencil guide hole 114 may extend in the first direction. The first side S1 in which the opening 112 is formed may be a top surface of the body cover 110, or a right or left side surface connected to the top surface. The first side S1 and the second side S2 may be substantially perpendicular to each other.

As mentioned later, the opening 112 may be an opening for a cutter unit, which is used as a passage through which a cutter unit 300 is demounted or mounted, and the pencil guide hole 114 may be an opening for holding a pencil, which is used as a passage through which a pencil is inserted and held in order to sharpen a pencil's writing point.

The body cover 110 may include a rear cover 118 covering an open rear side thereof. The rear cover 118 may be combined with the body cover 110 through a fastener such as a screw bolt. Additionally, the body cover 110 may include a chip box opening 116 in a front lower portion, into which a chip box 140 is detachably inserted.

In example embodiments, the electric pencil sharpener 100 may further include an opening/closing door 120 configured to open and close the opening 112. A tab for engagement/disengagement with the opening 112 may be provided in an end portion of the opening/closing door 120, and a user may press the tab to remove the opening/closing door 120 from the opening 112 of the body cover 110.

As illustrated in FIGS. 3, 4 and 6, the cutter platform 200 may be disposed within the body cover 110 and may support the cutter unit 300 such that the cutter unit 300 may be operatively connected to the motor 410.

In particular, the cutter platform 200 may include a support plate 202 installed within the body cover 110 to extend in a vertical direction (Z direction), and an open bracket 210, i.e., a hollow socket, extending in the first direction (X direction) from the support plate 202 to support the cutter unit 300.

The support plate 202 may have a rectangular shape when viewed in the first direction. The open bracket 210 may protrude from a front surface of the support plate 202. The open bracket 210 may be disposed in a right region of the front surface of the support plate 202.

The open bracket 210 may have a receiving space 212 configured to receive the cutter unit 300 such that the cutter unit 300 may be removable at least in the third direction (Z direction) from the open bracket 210. An upper portion of the open bracket 210 may have an open end. A lower portion of the open bracket 210 may have an open end. The receiving space 212 of the hollow socket may be connected to the opening 112 of the body cover 110. An inner space of the hollow socket may be exposed to the surrounding environment through the opening 112 of the body cover 110. A front end portion of the open bracket 210 may have a front opening 214 to which a pencil to be sharpened is inserted.

At least one seating groove 220, 230 may be formed in an inner surface of the open bracket 210 such that the cutter unit 300 may be seated and supported by the seating groove. A first seating groove 220 may be formed in an inner surface of a front body of the open bracket 210 to support a first end portion, i.e., a front end portion of the cutter unit 300. A second seating groove 230 may be formed in an inner surface of a rear body of the open bracket 210 to support a second end portion, i.e., a rear end portion of the cutter unit 300.

At least a portion of the seating groove may extend in the third direction (Z direction) to guide mounting and demounting of the cutter unit 300. The first seating groove 220 may extend in the third direction (Z direction) in the inner surface of the front body of the open bracket 210. An upper portion of the first seating groove 220 may be opened and a lower portion of the first seating groove 220 may have a first seating surface for supporting the first end portion of the cutter unit 300. The second seating groove 230 may extend in the third direction (Z direction) in the inner surface of the rear body of the open bracket 210. An upper portion of the second seating groove 230 may be opened and a lower portion of the second seating groove 230 may have a second seating surface for supporting the second end portion of the cutter unit 300. The second seating groove 230 may have a third seating surface 230a in the lowest middle portion of the rear body of the open bracket 210, and fourth and fifth seating surfaces 230b and 230c in both sides of the third seating surface 230a.

As illustrated in FIG. 5, the cutter unit 300 may include a cutter assembly having a cutter 304 for sharpening a pencil. For example, the cutter assembly may include a cutter holder 302 having a pencil insertion aperture 303, the cutter 304 supported by the cutter holder 302 and rotatable about a cutter shaft 306, and an assembly housing 310 supporting rotatably the cutter holder 302 and having a ring gear 312 in an inner circumferential surface, which is engaged with a planetary gear 308 in an end portion of the cutter 304. The cutter may have a helical cutter type, however, it may be understood that it may not be limited thereto and various cutter assemblies may be applicable.

In addition, the cutter unit 300 may further include a cutter gear 510 which is fixedly connected to an end portion of the cutter holder 302 opposite to the pencil insertion aperture 303 and integrally rotatable with the cutter holder 302. The cutter assembly may be disposed in a first side of the assembly housing 310 and the cutter gear 510 may be disposed in a second side of the assembly housing 310 opposite to the first side.

The assembly housing 310 may have at least one contact surface, i.e., pressurizing surface 320a, 320b, 320c, 320d for securely seating the cutter unit 300 in the open bracket 210. For example, a lower portion of the assembly housing 310 may have a first contact surface 320a, both side portions of the assembly housing 310 may have second and third contact surfaces 320b and 320c, and an upper portion of the assembly housing 310 may have a fourth contact surface 320d.

In example embodiments, the support plate 202 may support the motor unit 400 as well as the cutter unit 300. The motor unit 400 may be disposed in a left region of the front surface of the support plate 202. The motor unit 400 may be installed on the front surface of the support plate 202 through a fastener such as a bracket, a screw bolt, etc.

Additionally, the support plate 202 may support the gear mechanism 500 configured that the cutter unit 300 is operatively connected to the motor 410 of the motor unit 400. The gear mechanism 500 may include a plurality of gears installed in the support plate 202. The gears may transmit power from the motor 410 to the cutter unit 300. For example, the rotation of a drive shaft of the motor may be transmitted to the cutter unit 400 through a motor pinion, a middle gear 520 and a cutter gear 510.

However, it may be understated that configurations of the motor unit and the gear mechanism may not be limited thereto, and various configurations may be applicable.

The cutter unit 300 may be installed within the receiving space 212 of the open bracket 210. In here, the pencil insertion aperture 303 of the cutter unit 300 may be seated in the first seating groove 220 of the open bracket 210, and the assembly housing 310 of the cutter unit 300 may be seated in the second seating groove 230 of the open bracket 210. The first contact surface 320a, the second contact surface 320b and the third contact surface 320c of the assembly housing 310 may make contact with the third seating surface 230a, the fourth seating surface 230b and the fifth seating surface 230c of the second seating groove 230, respectively. The fourth contact surface 320d of the assembly housing 310 may be pressurized by a pressurizing protrusion (not illustrated) on a lower surface of the opening/closing door 120.

In addition, when the cutter unit 300 is seated on the open bracket 210, the cutter gear 510 of the cutter unit 300 may be engaged with the middle gear 520 through an open slit of the open bracket 210.

Thus, the cutter unit 300 may be securely mounted within the open bracket 210, and the power from the motor unit 400 may be transmitted to the cutter assembly through the middle gear 520 and the cutter gear 510.

As illustrated in FIGS. 7 to 9, the receiving space 212 of the open bracket 210 may be formed to extend in the third direction (Z direction), and the receiving space 212 may be connected to the opening 112 of the body cover 110. The front opening 214 of the open bracket 210 may be formed to extend in the first direction (X direction), and the front opening 214 may be connected to the pencil guide hole 114 of the body cover 110. A central axis C of the pencil guide hole 114 may be aligned with a rotational axis of the cutter unit 300 (cutter holder 302).

A pencil P may be inserted in the first direction (X direction) through the pencil guide hole 114 of the body cover 110 and then may be shaved away by the cutter unit 300. The cutter unit 300 may be ejected or inserted through the opening 112 of the body cover 110 in the third direction (Z direction) perpendicular to the first direction. Alternatively, by modifications of the open bracket, the cutter unit 300 may be ejected or inserted through opening in a fourth direction crossing the first direction, for example, at an acute angle or an obtuse angle.

A user may demount or mount the cutter unit 300 through the opening 112 of the body cover 110 as necessary. In case that a broken lead gets stuck in the cutter 304 of the cutter unit 300, a user may not disassemble the body cover 110, but a user may simply open the opening/closing door 120 and eject the cutter unit 300 through the opening 112 of the body cover 110, and then, remove the lead and mount again the cutter unit 300 in the open bracket 210 of the body cover 110. Further, when the cutter 304 of the cutter unit 300 wears down and needs to be replaced, a user may demount the old cutter unit 300 through the opening 112 of the body cover 110, and replace with and mount a new cutter unit in the body cover 110.

Although it is not illustrated in the figures, the electric pencil sharpener 100 may further include an opening/closing door switch (not illustrated) installed in the opening 112. When the opening/closing door 120 is seated in the opening 112, the opening/closing door switch may be pressed to be turned to an ON state where power is supplied to the motor 410, while when the opening/closing door 120 is removed from the opening 112, the opening/closing door switch may be opened to be turned to an OFF state where power supply to the motor 410 is halted.

The electric pencil sharpener 100 may further a switch (not illustrated) installed in a pencil holder 130 in the pencil guide hole 114. When a pencil is inserted to the pencil holder 130, the switch may be pressed so that power is turned on to operate the motor 410. The electric pencil sharpener 100 may further a chip box switch (not illustrated) installed in the chip box opening 116. When the chip box 140 is inserted to the chip box opening 116, the chip box switch may be pressed to be turned to an ON state where power is supplied to the motor 410, while when the chip box 140 is removed from the chip box opening 116, the chip box switch may be opened to turned to an OFF state where power supply to the motor 410 is halted.

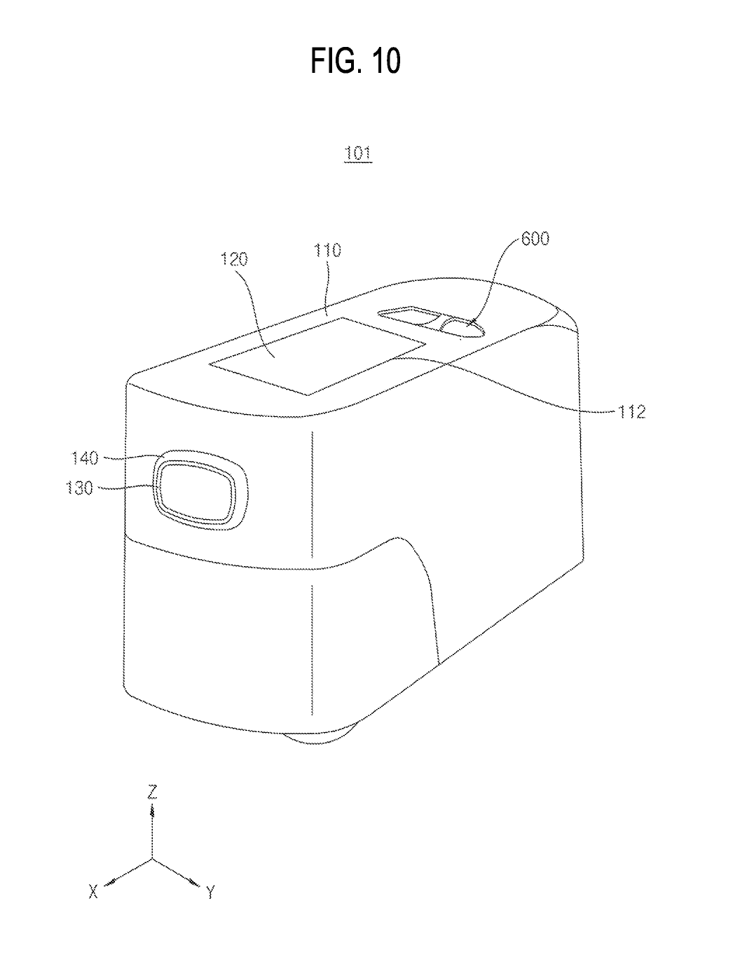

The electric pencil sharpener 100 may further a pencil lead diameter control device to adjust a diameter of the pencil lead in stages through a lead diameter adjustment dial (600, see FIG. 10). The electric pencil sharpener 100 may further include a motor overheat prevention device for preventing the motor from being overheated and damaged, an auto-stop device for sensing when the tip of the pencil is long enough and then stop to thereby prevent wasteful shaving, etc.

FIG. 10 is a perspective view illustrating an electric pencil sharpener in accordance with example embodiments. The electric pencil sharpener may be substantially the same as or similar to the electric pencil sharpener as described with reference to FIGS. 1 to 9, except for a shape of a body cover and an arrangement of a motor unit. Thus, same reference numerals will be used to refer to the same or like elements and any further repetitive explanation concerning the above elements will be omitted.

Referring to FIG. 10, an electric pencil sharpener 101 may include a body cover 110 with an opening/closing door 120 installed therein, a cutter platform received within the body cover 110, a cutter unit, a motor unit, a gear mechanism and various devices.

In example embodiments, the body cover 110 may be a box body having an overall rectangular parallelepiped shape. The body cover 110 may have an opening 112 in a first side S1, i.e., upper side, and a pencil guide hole 114, to which a pencil is inserted, in a second side S2, i.e., front side. A length in a first direction (X direction) of the body cover 110 may be greater than a width in a second direction (Y direction) of the body cover 110. Thus, the electric pencil sharpener 101 may have a longitudinal type of the body cover 110 having length greater than width.

In this case, an open bracket for receiving the cutter unit may be installed in a front side of the cutter platform to receive the cutter unit. The motor unit for driving the cutter unit may be installed in a rear side of the cutter platform.

In particular, a support plate may be installed to extend in a vertical direction (Z direction) within the body cover 110, and the open bracket may be disposed on a front surface of the support plate. The motor unit may be disposed on a rear surface of the support plate.

The open bracket may have a hollow receiving space in communication with an opening 112 of the body cover 110. The cutter unit may be seated and supported in the hollow receiving space.

A pencil may be inserted in the first direction (X direction) through a pencil guide hole 114 and then may be shaved away by the cutter unit. The cutter unit may be taken out of or put into through the opening 112 of the body cover 110 in the third direction (Z direction) perpendicular to the first direction.

A user may demount or mount the cutter unit through the opening 112 of the body cover 110 as necessary. A user may not disassemble the body cover 110, but simply open the opening/closing door 120 and take out the cutter unit through the opening 112 of the body cover 110. Further, a user may mount a cutter unit in the body cover 110 through the opening 112 of the body cover 110.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present invention. Accordingly, all such modifications are intended to be included within the scope of example embodiments as defined in the claims.

1. An electric pencil sharpener, comprising:
a motor configured to drive a cutter assembly for shaving a pencil;
a cutter platform including a bracket configured to removably attach to the cutter assembly, wherein the bracket includes a receiving space extending through the bracket in a first direction so that the bracket does not overlap in the first direction with the cutter assembly attached to the bracket; and
a body cover shaped to cover the cutter platform, wherein the body cover includes an opening that opens toward the first direction and a pencil guide hole that opens toward a second direction,
wherein the opening is in communication with the receiving space of the bracket in which the cutter assembly is received, and wherein the cutter assembly is attachable to the bracket through the opening by a user when the body cover covers the cutter platform.

2. The electric pencil sharpener of claim 1, wherein the bracket has at least one seating groove configured to support the cutter assembly.

3. The electric pencil sharpener of claim 2, wherein at least a portion of the seating groove extends in the first direction to guide attachment and detachment of the cutter assembly from the bracket.

4. The electric pencil sharpener of claim 1, wherein the second direction is substantially perpendicular to the first direction.

5. The electric pencil sharpener of claim 1, wherein the opening is larger than the cutter assembly so as to permit the cutter assembly to pass through the opening.

6. The electric pencil sharpener of claim 1, further comprising:
a separate door configured to open and close the opening in the body cover.

7. The electric pencil sharpener of claim 1, wherein the opening is provided in an upper side of the body cover.

8. The electric pencil sharpener of claim 1, wherein the cutter assembly includes
a cutter holder having a pencil insertion aperture,
a cutter supported by the cutter holder and rotatable about a cutter shaft, and
an assembly housing configured to rotate the cutter holder and having a ring gear in an inner circumferential surface, wherein the inner circumferential surface is shaped to engage with a planetary gear in an end portion of the cutter.

9. The electric pencil sharpener of claim 8, wherein the cutter assembly further includes a cutter gear fixedly connected to an end portion of the cutter holder and rotatable with the cutter holder.

10. The electric pencil sharpener of claim 8, wherein a central axis of the pencil guide hole is aligned with a rotational axis of the cutter holder.

11. An electric pencil sharpener, comprising:
a body cover including a pencil guide hole having a perimeter entirely in a first side of the body cover and an opening having a perimeter entirely in a second side of the body cover, wherein the pencil guide hole extends in a first direction and the opening opens in a second direction;
a cutter for shaving a pencil inserted through the pencil guide hole;
a motor configured to drive the cutter; and
a bracket within the body cover, wherein the bracket is positioned to expose the cutter through the opening when the cutter is attached to the bracket and when the body cover covers the bracket, and wherein the cutter is configured to attach to and detach from the bracket through the opening by a user.

12. The electric pencil sharpener of claim 11, further comprising:
a separate door configured to open and close the opening in the body cover.

13. The electric pencil sharpener of claim 11, wherein the second direction intersects with the first direction.

14. The electric pencil sharpener of claim 11, wherein the bracket has a hollow socket shape with two open ends.

15. The electric pencil sharpener of claim 11, wherein the bracket includes a first seating groove to support a first end of the cutter and a second seating groove to support a second end of the cutter.

16. The electric pencil sharpener of claim 11, wherein the bracket has a hollow receiving space in communication with the opening and shaped to receive the cutter.

17. The electric pencil sharpener of claim 11, further comprising:
a cutter holder having a pencil insertion aperture, wherein the cutter holder is configured to support the cutter and rotate the cutter about a cutter shaft; and
an assembly housing configured to rotatably support the cutter holder and having a ring gear in an inner circumferential surface, wherein the cutter includes a planetary gear in an end of the cutter configured to engage with the ring gear.

18. The electric pencil sharpener of claim 17, wherein the pencil insertion aperture of the cutter holder is seated in a first seating groove of the bracket, and wherein the assembly housing is seated in a second seating groove of the bracket.

19. The electric pencil sharpener of claim 17, wherein the cutter holder includes a cutter gear fixedly connected to an end portion of the cutter holder and rotatable with the cutter holder.

20. The electric pencil sharpener of claim 17, wherein a central axis of the pencil guide hole is aligned with a rotational axis of the cutter holder.
